(19) United States
(12) Patent Application Publication
(10) Pub. No.: US 2024/0317972 A1
(43) Pub. Date: Sep. 26, 2024

(54) POLYVINYL PHOSPHONATE AMINE SALTS AND FLAME RETARDED COMPOSITIONS CONTAINING THE SAME

(71) Applicant: ICL-IP America Inc., Tarrytown, NY (US)

(72) Inventors: Meng Zhang, Chappaqua, NY (US); Sergei Levchik, Croton on Hudson, NY (US); Andrew Piotrowski, Yorktown Heights, NY (US); George Schlinck, New York, NY (US); Gerald Alessio, Norwood, NJ (US)

(21) Appl. No.: 18/125,812

(22) Filed: Mar. 24, 2023

(51) Int. Cl. C08K 5/5333; C08K 5/19; C08K 5/3462; C08L 23/12

(52) U.S. Cl. CPC C08K 5/5333; C08K 5/19; C08K 5/3462; C08L 23/12; C08L 2201/02; C08L 2203/20

(57) ABSTRACT

A poly(vinyl phosphonate) amine salt flame retardant compound and methods of preparation. Flame retarded resin compositions containing poly(vinyl phosphonate) amine salts are also provided.

### FIELD OF THE INVENTION

The invention relates to organophosphorus-nitrogen containing flame retardants, together with their methods of preparation, and flame retarded resins containing the same.

### BACKGROUND OF THE INVENTION

Thermoplastic resins are important for the formation of various electronic devices and structures, such as electronic component casings, wire insulation, and recently battery covers for electric vehicles (EVs). However, thermoplastic resins, particularly, polyolefin resins, can be highly combustible. Therefore, flame retardancy is an important property of articles made, for example, from polyolefin and other thermoplastic resins.

Flame retardants are chemicals that resist ignition and/or slow down the spread of fire. They are often included in, for example, thermoplastics, textiles, and coatings. Typically, flame retardants are halogenated (i.e., brominated), organophosphorus or inorganic compounds. Because polyolefins are very flammable even the most efficient halogenated flame retardants usually require about 30-35% loading in the resin along with, e.g., 8-10% antimony trioxide synergist.

Organophosphorus and inorganic flame retardants tend to be even less efficient than halogenated flame retardants. Generally, these flame retardants require high loading (i.e., doses/volumes), which may compromise the mechanical properties of the article they are intended to protect, thereby increasing susceptibility to failure of polyolefins and other resin materials to which these types of flame retardants are applied. The high loading percentage can compromise the structural integrity of the article and can cause the properties of the final product to deteriorate. Higher loading of flame retardant also creates problems during processing/extruding as solid flame retardants can be incompatible with the molten polymers during processing.

Few intumescent flame retardants based on phosphorous and nitrogen-based compounds are available that can impart acceptably effective flame retardancy to polyolefins. Examples include, ammonium polyphosphates, piperazine polyphosphate, piperazine pyrophosphates, melamine polyphosphate, melamine pyrophosphates, ethylenediamine phosphate, and melamine phosphates. The loading percentage of intumescent flame retardants in polyolefin formulations has varied from 20-40 wt. %, more preferably from 28 to 35 wt. % of the total weight of the resin. However, these flame retardants have not proven to be fully satisfactory, in terms of ease of manufacture, typically requiring high shear and high temperature equipment. Moreover, in many instances, when these prior organophosphorus nitrogen-containing flame retardants are used to provide flame retardancy to resins, such as polyolefins, it is necessary to employ silanes or other types of surface coatings to the flame retardant to prevent dripping of the polyolefin during burning. Additionally, many of the prior flame retardants are too water soluble and therefore can be readily extracted from the polyolefin resins when subjected to different types of weather and moisture conditions.

Therefore, it is desirable to provide new, more conveniently synthesized, efficient and effective flame retardants that exhibit good flame retardancy and physical properties and overcome drawbacks of the prior art.

### SUMMARY OF THE INVENTION

The invention relates to the production of polymerized vinyl phosphonate amine salts and flame retarded compositions made therewith. Such flame retardants can have excellent intumescent flame retardant properties in polyolefin and other resin applications. Polymerized vinyl phosphonate salts in accordance with the invention can be made more easily than other organophosphorus and nitrogen-containing flame retardants. They also exhibit improved physical properties such as low or acceptable water solubility and water extraction from the resins in which they are incorporated, as well as preventing dripping of the polyolefin during burning. They are conveniently and effectively included in flame retarded resin compositions, which can be used in the manufacture of electrical and electronic components such as casings, wire and cable coverings and others.

Improved flame retardant compounds, methods of their preparation, and resins including the same are provided. Preferred poly(vinyl phosphonate) amine salt flame retardants in accordance with the invention can have the following general formula (I):

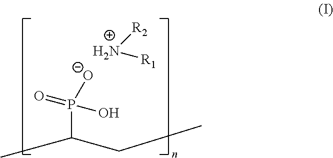

R₁ is H, alkyl having 1-4 carbon atoms, or [(CH₂)pR₃]q;
R₂ is H, alkyl having 1-4 carbon atoms, [(CH₂)pR₃]q, or

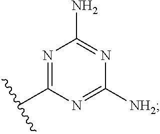 [SMILES: *c1nc(N)nc(N)n1]

or
R₁ and R₂ together with nitrogen (N) and carbon (C) atoms, to which they are bonded respectively, represent a 5-6 membered saturated heterocyclic group, preferably piperazine;
R₃ is NR₄R₅ wherein R₄ and R₅ represent independently H or, alkyl having 1-4 carbon atoms, optionally substituted with amino (NH₂) group;
n is from 2 to 100, preferably from 2 to 25, more preferably 2 to 10, and in other embodiments of the invention, n is 3 to 25, more preferably 3 to 10;
p is from 1 to 4; and
q is from 1 to 20.

Methods of preparation and flame retarded resin compositions, especially polyolefin resins such as polypropylene, containing poly(vinyl phosphonate) amine salts in accordance with the invention are also provided.

### DETAILED DESCRIPTION OF THE PREFERRED EMBODIMENTS

The present disclosure may be understood more readily by reference to the following detailed description. It is to be understood that this disclosure is not limited to the specific materials, methods, conditions or parameters described and/or shown herein, and that the terminology used herein is for the purpose of describing particular embodiments by way of example only and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

The invention relates to conveniently synthesized poly(vinyl phosphonate) amine salt flame retardants having an acceptably high flame retarding properties. These compounds are suitably compatible with thermoplastic resin substrates to provide suitable flame resistant resin structures, useful, for example in EVs, cable and wire coverings, electronic equipment, and other electronic components having high thermal stability and low water solubility.

Preferred methods of preparing these compounds include reacting vinyl phosphonic acid with amine, such as ammonia, piperazine, pyrrolidine, piperidine, melamine, ethylenediamine and polyethyleneimine to obtain vinyl phosphonate amine salt monomers. Then the monomers are polymerized using radical initiators such as dicumyl peroxide or AIBN to obtain poly(vinyl phosphonate) amine salt. The reaction condition is mild below 180° C., more preferably below or at 150° C.

In another embodiment of the invention, the flame retardant compounds can be made by initially polymerizing the phosphonic acid, such as by using radical initiators such as AIBN or dicumyl peroxide, and then reacting the resulting polyphosphonic acid with the desired amine, such as ammonia, piperazine, melamine, ethylenediamine, or polyethylenimine to form the flame retardant polymer salt of the invention. The reaction condition is mild, preferably below 180° C., more preferably below or at 150° C.

The invention also relates to resin compositions, for example, thermoplastic resins containing flame retardants that can be used, for example, in the field electrical and electronic equipment, such as various applications in EVs. Exemplary thermoplastic polymer resins include polyolefins, such as polyethylene, polypropylene, polycarbonates, polystyrene, polyamides, polyesters, and the like.

The flame retardants in accordance with the invention are based on phosphorous and nitrogen-containing compounds that impart flame retardancy to the polymers to which they are added. The amine salts in accordance with the invention and included within the scope of formula (I) above include piperazine polyvinyl phosphonate, ammonium polyvinyl phosphonate, melamine polyvinyl phosphonate, and polyethylenimine polyvinyl phosphonate and their derivatives. The flame retardants in accordance with the invention can also be combined with existing flame retardants, and can exhibit synergistic flame retarded effects.

Furthermore, the flame retarded resin compositions may contain common suitable additives, such as antioxidants, anti-dripping agents, and the like. The total loading percentage of the flame retardants into resins, such as polyolefin-based resins, in accordance with the invention, can vary from 10 wt. % to 40 wt. %, preferably in the range from 28 wt. % to 35 wt. % of the total weight of the resin material. Furthermore, at least 10 wt. %, preferably at least 15 wt. % of the loading into the resin should be the Poly(vinyl phosphonate) amine salt in accordance with the invention.

Preferred compounds in accordance with formula (I) of this invention include piperazine polyvinyl phosphonate, ammonium polyvinyl phosphonate, melamine polyvinyl phosphonate, and polyethylenimine polyvinyl phosphonate. Compared to known commercial intumescent materials, such as piperazine pyrophosphate, compounds in accordance with the invention are easier to make. For example, they do not require the same high shear/high temperature equipment generally used to prepare the known materials.

It has also been found that the polyvinyl phosphonate amine salts in accordance with the invention can reduce or prevent the dripping of the polyolefin resins containing these flame retardants during burning, without the common treatment with a silane or other type of surface coating of the flame retardant compound. Also, the combination of polyvinyl phosphonate amine salts, such as piperazine polyvinyl phosphonate with melamine pyrophosphate has been shown to have similar physical properties when blended into polypropylene resins, as compared to other commercial intumescent flame retardants (FRs). Furthermore, the water extraction of such formulations in polypropylene is also advantageously lower or comparable with prior flame retardants. The polymeric nature of the polyvinyl phosphonate salt is believed to make it less soluble in water. This low water extraction property can provide enhanced weather resistance and other water resistance advantages.

In addition to the poly(vinyl phosphonate) amine salts in accordance with the invention, flame retardant compositions in accordance with the invention can include other nitrogen and phosphorus containing compounds, such as e.g., ammonium polyphosphates, piperazine polyphosphates, ammonium pyrophosphates, piperazine pyrophosphates, melamine polyphosphates, melamine pyrophosphates, ethylenediamine phosphate, and their derivatives. Synergistic effects are believed to occur.

### EXAMPLES

The following examples are provided for purposes of illustration only and are not to be interpreted as limiting the scope of the invention.

Polypropylene (PP) resin (1112 PP) was obtained from Pinnacle. Melamine pyrophosphate (Aflammit® PMN370) was obtained from Thor. Irganox B225 was obtained from BASF as an antioxidant/thermal stabilizer. PTFE (FA-600) was obtained from Daikin as an anti-dripping agent.

A flame retardant composition shown in Table 1 were mixed into the PP resin composition, and the mixture was either directly blended in a Brabender mixer at 170-200° C. followed with pressing to obtain test specimens, or extruded using a small-scale Brabender extruder at 200° C. to obtain pellets. The resulting pellets from extruder were dried at 75° C. for 24 h, and then molded through an Arburg Injection Molder machine, wherein maximum temperature of its cylinder had been adjusted to 220° C., to provide test specimens. The test specimens were subjected to the tests for flammability and physical properties as described below.

### UL Flammability 94V Test:

UL-94 vertical burning test was measured with a specimen size of 127×12.7×1.6 mm according to the standard ASTM D 3801. The specimen was positioned vertically, and a burner was applied to the lower end of the specimen for 10 seconds. After 10 seconds, the flame was removed, and time required to self-extinguish (burning time) was recorded. As soon as the flame extinguished, the flame was immediately applied for another 10 seconds. Again the burning time was recorded. The test allows the classification of the material at the 94 V-0, 94 V-1, and 94 V-2 levels depending on the burning time of the samples and whether they drop flaming drips.

### Tensile Properties Test:

The tensile tests were conducted according to the test standard ASTM D638 at ambient temperature. Specimens used were tensile bars 3.2 mm, and strain was applied at 2.0 in/min.

### IZOD Pendulum Impact Test:

The Izod notched impact measurements were performed according to ASTM D256. Specimens used were 3.2 mm bars, cut in half perpendicular to the length, then notched. Windage and friction loss was 0.03%.

### Heat Deflection Temperature Test:

Heat deflection temperature was measured according to the test standard ASTM D648 by using 3.2 mm specimens. The test was conducted under 1.82 MPa, and the heat increase rate was 2.00° C. per minute.

### Water Extraction Test:

Water Extraction Test was performed by using 1.6 mm specimens bars which were cut in half perpendicular to the length. The rounded side was used to ensure uniform sample size. Then the specimens were placed in a small vial filled with deionized water, sealed, and heated at 60° C. for 24 h. After heating, the water was measured for conductivity using a conductivity meter.

### Synthesis and Testing of Poly (Vinyl Phosphonate) Ammonium Salts

### Example 1—Synthesis of Poly(Vinyl Phosphonate) Ammonium Salt

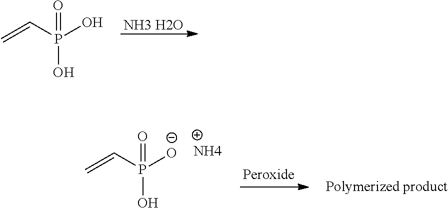

Vinyl phosphonic acid (90% pure, 25 g, 208.3 mmol) was added into a 250 mL flask. Ammonia (NH₃) (28-30% in water, 12.7 g, 208.3 mmol) was added dropwise. The reaction mixture was heated to 100° C. for 2 hours. The ammonium vinyl phosphonic acid intermediate was a thick liquid. About 0.25 g of dicumyl peroxide was added into the ammonium vinyl phosphonic acid intermediate, and the mixture was stirred at 100° C. overnight. The mixture was then poured into a Teflon coated pan and cured at 150° C. for 6 h. A heat absorption peak around 150° C. in Differential Scanning Calorimetry (DSC) indicated the formation of polymer. The cured product was a yellow solid, with TGA 98% at 218° C., 95% at 251° C., and 90% at 288° C. The sample intumesced in the TGA pan. The product was ground, blended with pentaerythritol (weight ratio 3:1), and tested in polypropylene (PP).

### Example 2—Synthesis of Poly (Vinyl Phosphonate) Piperazine Salt

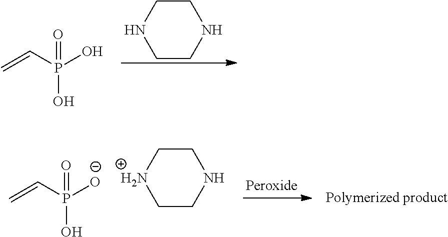

Vinyl phosphonic acid (90% pure, 20 g, 166.6 mmol) was added into a 250 mL flask with 50 mL of water. Piperazine (14.3 g, 166.6 mmol) was added to the flask. The reaction mixture was heated at 100° C. for 2 h. About 0.32 g of dicumyl peroxide was added into the intermediate, and the intermediate mixture was stirred at 100° C. for 2 h. Water was partially distilled to concentrate the product solution. Then the solution was poured into a Teflon coated pan and cured at 150° C. overnight. A heat absorption peak around 150° C. in Differential Scanning Calorimetry (DSC) indicated the formation of polymer. About 33 g of a white solid cured product was collected. TGA of the product is 98% at 301° C., 95% at 320° C., and 90% at 333° C. The sample intumesced in the TGA pan. A blend (60:40) of this sample with AFLAMMIT® PMN 370 by Thor, a melamine pyrophosphate based flame retardant, was tested in PP.

### Example 3—Synthesis of Poly (Vinyl Phosphonate) Piperazine Salt

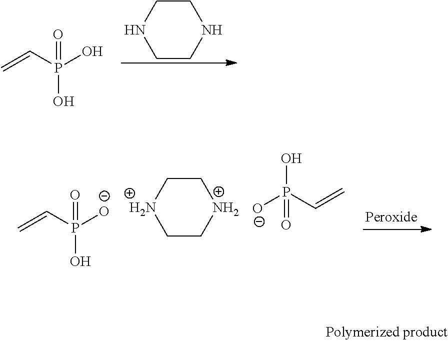

To further assess the water resistance, vinyl phosphonic acid was reacted with piperazine (2:1 instead of 1:1 mole ratio) to make piperazine di(vinyl phosphonic acid), followed by polymerization. Vinyl phosphonic acid (90% pure, 20 g, 166.6 mmol) was added into a 100 mL flask with 25 mL of water. Piperazine (7.2 g, 83.3 mmol) was added in portion. The intermediate reaction mixture was heated at 100° C. for 2 h. About 0.27 g of dicumyl peroxide was added into the intermediate, and the mixture was stirred at 100° C. for 2 h. Water was partially distilled to concentrate the product solution. Then the solution was poured into a Teflon coated pan and cured at 150° C. overnight. About 26 g of white cured solid product was collected. TGA of the product is 98% at 326° C., 95% at 345° C., and 90% at 356° C. The sample intumesced in the TGA pan. The sample was not very soluble in water. A blend of this sample with AFLAMMIT® PMN370 (60:40) was tested in PP

### Example 4—Scale-Up Synthesis of Poly(Vinyl Phosphonate) Piperazine Salt

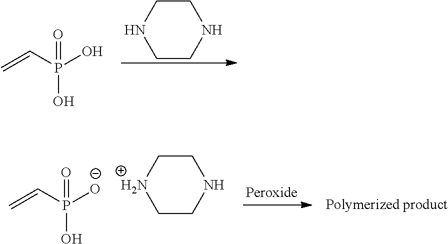

The small-scale sample (Example 2) of Poly(Vinyl Phosphonate) Piperazine Salt (1:1 mole ratio of piperazine to vinyl phosphonic acid) gave positive results with good water resistance, this product is scaled up for extruding and more physical property testing. Vinyl phosphonic acid (90% pure, 125.0 g, 1.0 mol) was added into a 1 L flask with 300 mL of water. Piperazine (89.7 g, 1.0 mol) was added in portion. The reaction mixture was heated at 100° C. for 2 h. About 2.1 g of dicumyl peroxide was added into the intermediate, and the mixture was stirred at 100° C. for 2 h. Water was partially distilled to concentrate the product solution. Then the solution was poured into a Teflon coated pan and cured at 150° C. overnight. TGA showed that there was still water residue in the product. therefore, the cured product was ground coarsely with a 10 mesh screen and then cured at 150° C. to remove all water. About 200 g of light yellow solid was collected. TGA of the product is 98% at 281° C., 95% at 304° C., and 90% at 323° C. The product was ground again through a 20 mesh screen and blended with PMN370 (60:40) for the physical properties in PP testing.

### Example 5—Synthesis of Poly (Vinyl Phosphonate) Melamine Salt

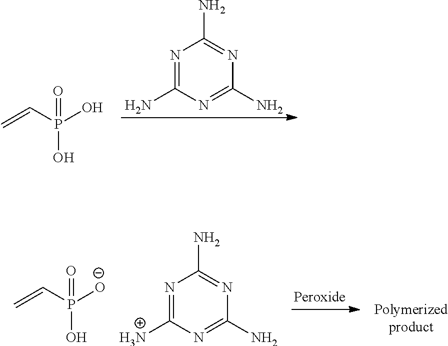

Vinyl phosphonic acid (90% pure, 16.3 g, 135.8 mmol) was added into a 250 mL flask with 30 mL of water. Melamine (17.1 g, 135.8 mmol) was added in portion. The reaction mixture was heated at 100° C. for 2 h and formed a white intermediate suspension. About 0.33 g of dicumyl peroxide was added into the intermediate, and the mixture was stirred at 100° C. for 2 h. Then the suspension was poured into a Teflon coated pan and cured at 150° C. overnight. A heat absorption peak around 150° C. in Differential Scanning Calorimetry (DSC) indicated the formation of polymer. About 27 g of light yellow solid product was collected. TGA of this product is 98% at 234° C., 95% at 262° C., and 90% at 334° C. The sample intumesced in the TGA pan, but less than prior samples.

### Example 6—Synthesis of Poly (Vinyl Phosphonate) Polyethylenimine Salt

Vinyl phosphonic acid (90% pure, 15.4 g, 125.0 mmol) was added into a 100 mL flask with 20 mL of water. Polyethylenimine (Mw˜800, 7.6 g, 125.0 mmol) was added slowly. The reaction mixture was heated at 100° C. for 2 h. About 0.2 g of dicumyl peroxide was added into the intermediate, and the mixture was stirred at 100° C. for 2 h. Water was partially distilled to concentrate the product solution. The solution was then poured into a Teflon coated pan and cured at 150° C. overnight. A heat absorption peak around 150° C. in Differential Scanning Calorimetry (DSC) indicated the formation of polymer. About 20 g of yellow solid product was collected. TGA of the product is 98% at 266° C., 95% at 301° C., and 90% at 337° C. The sample intumesced in the TGA pan. This sample was blended with piperazine pyrophosphate at 1 to 1 wt ratio and tested in polypropylene for flammability performance.

### Example 7—Synthesis of Poly (Vinyl Phosphonate) Piperazine Salt

Example 7 synthesizes poly (vinyl phosphonate) piperazine salt by first polymerizing the phosphonic acid, and then reacting the polymer with the amine.

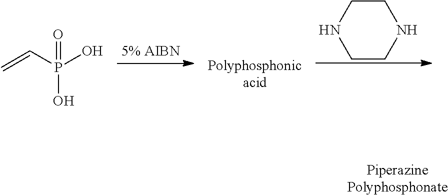

Vinyl phosphonic acid (90% pure, 17.9 g, 149.5 mmol) was added into a 250 mL flask with 10 mL of water. AIBN (0.9 g, 5 wt %) was added, and the reaction mixture was heated at 100° C. for 8 h. The reaction mixture became very viscous, indicating the formation of a polymer. The sample was not soluble in DMF, IPA and methylene chloride during analysis. The sample is soluble or miscible in water. The polymer intermediate was reacted with piperazine directly. Piperazine (12.9 g, 149.5 mmol) was added into the intermediate slowly, and the mixture was stirred at 100° C. for 2 h. Then the suspension was poured into a Teflon coated pan and cured at 150° C. for 10 h. About 27 g of white solid product was collected. TGA of the product is 98% at 228° C., 95% at 266° C., and 90% at 302° C. The sample intumesced in the TGA pan. The sample was ground, blended with PMN370 at 60/40 wt ratio, and tested in PP with 30% loading.

### Application Examples and Comparative Example

The composition and physical properties of the Poly (Vinyl Phosphonate) Amine Salt formulations are reported below in Table 1, and compared with a commercially available piperazine pyrophosphate and melamine pyrophosphate benchmark. The invention examples 8-10 and 12 passed V-0, with no dripping during burning. The water extraction data of the Example 9 was improved and was closer to that of the benchmark. IZOD Impact and tensile strength of Example 9 are higher than those of the commercial benchmark.

TABLE 1
Flame Retardant Composition And Physical Properties

| | Invention | Invention | Invention | Invention | Invention | Comparative |
|---|---|---|---|---|---|---|
| | Example 8 | Example 9 | Example 10 | Example 11 | Example 12 | Example 13 |
| PP Resin | 69.6% * | 69.6 | 69.6% | 69.6% | 69.6% | 69.8% |
| Composition | | | | | | |
| Flame Retardant | 30.0% | | | | | |
| Formulation of | | | | | | |
| Example 1 | | | | | | |
| Flame Retardant | | 30.0% | | | | |
| Formulation of | | | | | | |
| Example 2 & 4 | | | | | | |
| Flame Retardant | | | 30.0% | | | |
| Formulation of | | | | | | |
| Example 3 | | | | | | |
| Flame Retardant | | | | 30.0% | | |
| Formulation of | | | | | | |
| Example 6 | | | | | | |
| Flame Retardant | | | | | 30.0% | |
| Formulation of | | | | | | |
| Example 7 | | | | | | |
| Commercial | | | | | | 30.0% |
| Piperazine | | | | | | |
| pyrophosphate | | | | | | |
| and melamine | | | | | | |
| pyrophosphate | | | | | | |
| Daikin FA-600 | 0.2% | 0.2% | 0.2% | 0.2% | 0.2% | |
| (PTFE) | | | | | | |
| Irganox B225 | 0.2% | 0.2% | 0.2% | 0.2% | 0.2% | 0.2% |
| UL-94V (1.6 mm) | V-0 | V-0 | V-0 | V-2 | V-0 | V-0 |
| | no drips | no drips | no drips | | no drips | no drips |
| HDT (° C.) | NA | 66.9 | NA | NA | NA | 73.4 |
| IZOD Impact (J/m) | NA | 22.60 | NA | NA | NA | 15.96 |
| Tensile | NA | 26.2 | NA | NA | NA | 25.3 |
| Strength (MPa) | | | | | | |
| Elongation at | NA | 5.13 | NA | NA | NA | 22.57 |
| Break (%) | | | | | | |
| Water | 1387 | 156 | 524 | 431 | 184 | 100 |
| Extraction (μS) | | | | | | |

* All ingredient percentages are on a weight basis.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A flame retardant poly(vinyl phosphonate) amine salt having the general formula (I): 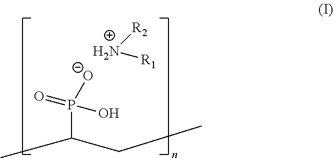
wherein:
R₁ is H or alkyl having 1-4 carbon atoms or [(CH₂)pR₃]q;
R₂ is H or alkyl having 1-4 carbon atoms or [(CH₂)pR₃]q or 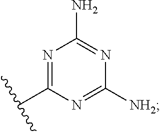 [SMILES: *c1nc(N)nc(N)n1]
or
R₁ and R₂ together with nitrogen (N) and carbon (C) atoms, to which they are attached respectively, represent a 5-6 membered saturated heterocyclic group;
R₃ is NR₄R₅ wherein R₄ and R₅ represent independently H or alkyl having 1-4 carbon atoms, optionally substituted by amino (NH₂);
n is from 2 to 100;
p is from 1 to 4; and
q is from 1 to 20.

2. The flame retardant of claim 1, wherein R₁ is H or alkyl having 1-4 carbon atoms.

3. The flame retardant of claim 1, wherein R₁ is H or alkyl having 1-4 carbon atoms and R₂ is H or alkyl having 1-4 carbon atoms.

4. The flame retardant of claim 1, wherein R₁ is [(CH₂)pR₃]q.

5. The flame retardant of claim 1, wherein R₂ is

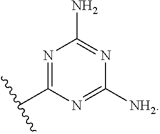 [SMILES: *c1nc(N)nc(N)n1]

6. The flame retardant of claim 1, wherein n is 2 to 25.

7. The flame retardant of claim 1, wherein n is 3 to 25.

8. The flame retardant of claim 1, wherein the poly(vinyl phosphonate) amine salt is selected from the group consisting of piperazine polyvinyl phosphonate, ammonium polyvinyl phosphonate, melamine polyvinyl phosphonate, and polyethylenimine polyvinyl phosphonate.

9. The flame retardant of claim 1, wherein the salt is ammonium polyvinyl phosphonate.

10. The flame retardant of claim 1, wherein the salt is piperazine polyvinyl phosphonate

11. A flame retarded thermoplastic resin composition, comprising the poly(vinyl phosphonate) amine salt of claim 1, and a thermoplastic resin.

12. The thermoplastic resin composition of claim 11, wherein the thermoplastic resin comprises a polyolefin.

13. The thermoplastic resin composition of claim 12, wherein the thermoplastic polymer comprises polypropylene.

14. The thermoplastic resin composition of claim 11, further comprising at least one of ammonium polyphosphate, ammonium pyrophosphate, piperazine polyphosphate, piperazine pyrophosphate, melamine polyphosphate, ethylenediamine phosphate, or melamine pyrophosphate.

15. The flame retarded thermoplastic resin composition of claim 14, wherein the polyolefin is polypropylene.

16. The flame retarded thermoplastic resin composition of claim 11, wherein the flame retardant is present in at least 10% by weight of the resin composition.

17. A plastic molded component adapted for use in electrical or electronic equipment, said component comprising the flame retarded thermoplastic resin composition of claim 11.

18. A method of preparing the flame retardant poly(vinyl phosphonate) amine salt of claim 1, comprising the step of reacting vinyl phosphonic acid with an amine, followed by the polymerization of vinyl phosphonate amine salt.

19. The method of claim 18, wherein the amine is selected from the group consisting of piperazine, ammonium, melamine, ethylenediamine, and polyethylenimine.

20. A method of preparing the flame retardant poly(vinyl phosphonate) amine salt of claim 1, comprising the step of polymerizing vinyl phosphonic acid to form polyvinyl phosphonic acid, followed by the reaction of the polyvinyl phosphonic acid with an amine.

21. The method of claim 20, wherein the amine is selected from the group consisting of piperazine, ammonium, melamine, ethylenediamine, and polyethylenimine
